(19) United States
(12) Patent Application Publication
(10) Pub. No.: US 2006/0142084 A1
(43) Pub. Date: Jun. 29, 2006

(54) Rumble joystick with flashing light effects

(76) Inventor: Chin-Tung Chen, Kaohsiung City (TW)

Correspondence Address: LEONG C LEI, PMB # 1008, 1867 YGNACIO VALLEY ROAD, WALNUT CREEK, CA, 94598, US

(21) Appl. No.: 11/020,324

(22) Filed: Dec. 27, 2004

(51) Int. Cl. A63F 13/00

(52) U.S. Cl. 463/38

(57) ABSTRACT

A rumble joystick with flashing light effects for playing a TV game includes ajoystick and a flashing light circuit being connected to LED and DC motor; an eccentric pendant being adapted to the DC motor; the pendant being disposed below the pendant in front of the DC motor; a signal of a specific voltage sent from the circuit to activate the LED and DC motor at the same time for the pendant to create flashing light effects in adding more fin to the TV game.

### BACKGROUND OF THE INVETION

(a) Technical Field of the Invention

The present invention is related to a flashing light construction applied in a rumble joystick, and more particularly to an eccentric pendant provided with excellent deflection to drive the LED provided below the pendant to emit light when the joystick vibrates to create dazzling visual effects.

(b) Description of the Prior Art

Whereas there is a large population of PC and TV game (PS2, GameCube, XBOB), the entertainment industry is doing its best to continue introducing new games and peripherals to satisfy the players. While treating the players fast and better pictures, rumble effects are added to the joystick to promote exciting sense of the surrounding experience.

The joystick is operated to manipulate the leading character in the game. By operating the arrow keys and functional keys on the joystick, the player makes the leading character to act as desired by the player. When the joystick supports the rumble effects, the joystick creates the rumble effects in case of any collision, attack or accident as the story goes in the game for the player to feel like he were experiencing the same as is the leading character in the game to add more fun to the game. To achieve the purpose, a motor and a biased weight provided at the spindle of the motor are built in the joystick to take advantage of the unbalanced installation for the driving motor to naturally create shaking.

However, some players may get numb with the rumble sensation due to the violent operation of the hand or getting too absorbed in the picture of the game while others may get indifference in the rumble effects.

### SUMMARY OF THE INVENTION

The primary purpose of the present invention is to provide a rumble joystick with flashing light effects adapted to XBOX, PS2, GameCube TV games and PC. To achieve the purpose, the flashing light construction includes a flashing light circuit connected to an LED or multiple LEDs, a DC motor, and an eccentric pendant. The pendant is made of a transparent material that deflects the light. Upon receiving the message transmitted from the host of the game, the flashing light circuit activates the LED and the rumble motor at the same time for the light beams emitted from the LED are deflected at different angles by the eccentric pendant to create interesting and dazzling flashing light effects.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a circuit diagram of the present invention.

FIG. 2 is a schematic view showing the construction of the present invention.

FIG. 3 is a perspective view of an eccentric pendant in the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the finction and arrangement of the elements described without departing from the scope of the invention as set forth in the appended claims.

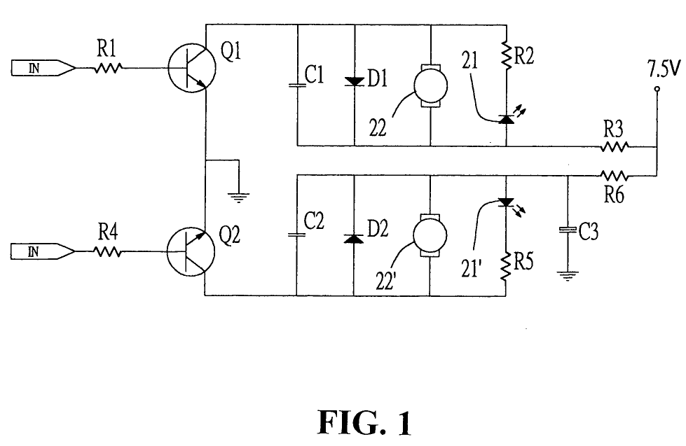

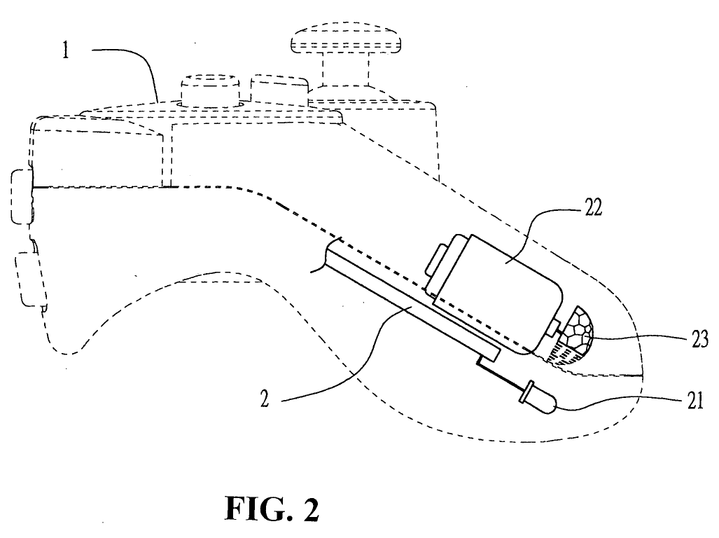

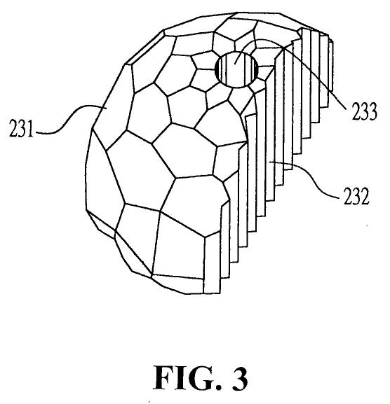

Referring to FIGS. 1 and 2, a preferred embodiment of the present invention is essentially comprised of a joystick (1) and a flashing light circuit (2). Wherein, the flashing light circuit (2) is connected to an LED or multiple LEDs (21) and a DC motor (22). The DC motor (22) is adapted with an eccentric pendant (23), or two eccentric pendants as required. The DC motor (22) is built in the joystick at where appropriately. The LED (21) is provided at where below the eccentric pendant (23) at the front end of the DC motor (22). As illustrated in FIG. 3, the eccentric pendant (23) is made of a transparent material is a profile in a volume approximate greater than a quarter of a sphere. The arc surface of the eccentric pendant (23) is provided with multiple deflection planes (231), and the vertical cut of the arc surface is provided with multiple deflection stripes (232). An axial hole (233) is provided at where passes through the center of the sphere. The eccentric pendant (23) is tightly secured to one end of the spindle of the DC motor (22) through the axial hole (233).

As illustrated in FIG. 1, when the flashing light circuit (2) at its signaling end generates a signal of a specific voltage, both power transistors (Q1, Q2) are opened to further open a 7.5V loop and two LEDs (21, 21′) and two DC motors (22, 22′) are activated at the same time for the eccentric pendant (23) to produce rumble effects on the joystick due to unbalanced revolution. Light beams emitted from both LEDs (21, 21′) for being deflected by its excellent deflection profile on its surface create dazzling and versatile flashing light effects at the same time the joystick is delivering the rumble effects.

While experiencing the surrounding effects as were in the same scenario that a leading character is in the story of the game, the player is put in a highly intensive sensation created by the unpredictable change of the dazzling effects of the light thanks to the rumble and flashing light effects created in time as the story of the game develops.

The present invention provides an improved structure of a joystick creates for the TV game player the exciting experience of rumble and dazzling light effects at the same time. Therefore, the application for a utility patent is duly filed accordingly.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A rumble joystick with flashing light effects includes a joystick and a flashing light circuit; the flashing light circuit being connected to one LED or multiple LEDs and a DC motor; the DC motor being adapted with an eccentric pendant; the LED or LEDs being provided at where below the eccentric pendant; the flashing light circuit generating a signal of a specific voltage; both of the LED or LEDs and the DC motor being activated by the signal at the same time; and the LED or LEDs creating flashing light effects as the light beams emitted from the LED or LEDs is deflected by the eccentric pendant.

2. The rumble joystick with flashing light effects of claim 1 wherein the profile of the eccentric pendant is approximately greater than the volume of a sphere; the arc surface of the eccentric pendant being provided with multiple deflection planes; the vertical cut of the arc surface being provided with multiple deflection stripes; an axial hole being disposed at where passes through the center of the sphere; and the eccentric pendant being tightly secured to one end of the spindle of the DC motor through the axial hole.

3. The rumble joystick with flashing light effects of claim 1 wherein the eccentric pendant is made of a transparent material.

4. The rumble joystick with flashing light effects of claim 1 wherein one LED or multiple LEDs built in the flashing light construction is made in different colors.
